(19) United States
(12) Patent Application Publication
(10) Pub. No.: US 2004/0230498 A1
(43) Pub. Date: Nov. 18, 2004

(54) Methods of returning a rental vehicle to a rental agency facility

(76) Inventors: Kelly L. Zimmerman, Apex, NC (US); Scott P. Zimmerman, Apex, NC (US)

Correspondence Address: Scott P. Zimmerman, P.O. Box 3822, Cary, NC, 27519, US

(21) Appl. No.: 10/870,588

(22) Filed: Jun. 17, 2004

Related U.S. Application Data
(62) Division of application No. 09/776,188, filed on Feb. 3, 2001.
(63) Continuation-in-part of application No. 09/455,145, filed on Dec. 6, 1999, now abandoned.

(51) Int. Cl. G06F 17/60

(52) U.S. Cl. 705/26

(57) ABSTRACT

Methods are disclosed for returning a rental vehicle to a rental agency facility. One method detects a location of the rental vehicle and commands the rental vehicle to wirelessly communicate diagnostic information. The diagnostic information includes at least one of mileage of the rental vehicle, fuel contained in the rental vehicle, and a number identifying the rental vehicle. Another method wirelessly receives the diagnostic information from the rental vehicle and forwards the diagnostic information to the rental agency. The diagnostic information may be wirelessly received by a manufacturer of the rental vehicle and forwarded from the manufacturer of the rental vehicle to the rental agency. Still another method receives the diagnostic information from the manufacturer and generates a record of a rental transaction using the diagnostic information. The manufacturer of the rental vehicle may be requested to obtain the diagnostic information.

### CROSS-REFERENCE TO RELATED APPLICATIONS

This application is a divisional of U.S. application Ser. No. 09/776,188 filed Feb. 3, 2001. This application is also a continuation-in-part of U.S. application Ser. No. 09/455,145 filed Dec. 6, 1999, and this application also claims the benefit of U.S. Provisional Application No. 60/182,624 filed Feb. 15, 2000.

### BACKGROUND OF THE INVENTION

1. Field of the Invention

This invention generally relates to vehicles and, more particularly, to methods and systems for acquiring and communicating vehicular data.

2. Description of the Related Art

Vehicle manufacturers use computers to control and to detect errors in vehicle components. Each computer may receive data from several sensors, and the computer then uses this data to control fans, valves, relays, and other components. When a computer receives data that is unfamiliar or that is outside programmed limits, the computer is usually programmed to send an error message. This error message is commonly displayed on the vehicle's instrument panel as a flashing light or other indication. The driver is then alerted to return the vehicle to a service center for repair.

Any error message or other data from the computer must currently be requested or downloaded by service personnel. A service technician or engineer uses a specially programmed device to interface with the computer. This specially programmed device is connected to the computer to read sensor data, computer data, and error codes. These specially programmed devices are expensive to purchase, and these specially programmed devices can differ between manufacturers and even between model years. Furthermore, expensive labor costs are unnecessarily required to interface with the computer and read any data or error codes. This human interaction is also prone to error.

There is, accordingly, a need in the art for a method of acquiring vehicle data which is less costly, which reduces human error, and which is always cost effective to implement.

### BRIEF SUMMARY OF THE INVENTION

A vehicular data acquisition and transmission device resolves the aforementioned problems. The vehicular data acquisition and transmission device includes a communication device disposed within a vehicle. The vehicular data acquisition and transmission device receives vehicular data and initiates a communication. This initiated communication includes a representation of the vehicular data. The vehicular data is selected from the group consisting of engine management information, powertrain management information, chassis management information, and electrical management information. The vehicular data may also include maintenance information, diagnostic error code information, odometer, fuel, or vehicle identification number (VIN) information.

A method of communicating the vehicular data is also disclosed. The method includes initiating a communication representing the vehicular data from a vehicle. The method could include initiating a wireless communication representing the vehicular data. The method could include initiating a communication of the vehicular data from the vehicle to a service center or to a dealership or to a manufacturer. The method may include initiating a communication of the vehicular data from the dealership or service center to the manufacturer. The method could include initiating a communication of the vehicular data over the Internet. The method additionally could include initiating a wireless communication of the vehicular data from the dealership to a manufacturer or from the vehicle to a manufacturer. The method alternatively could include initiating a wireless communication of the vehicular data from the vehicle to a rental agency.

### BRIEF DESCRIPTION OF THE SEVERAL VIEWS OF THE DRAWINGS

These and other features, aspects, and advantages of the present invention will be better understood when the following Detailed Description of the Invention is read with reference to the accompanying drawings, wherein:

FIG. 1 is a schematic of a vehicle incorporating a vehicular data acquisition and transmission device;

FIG. 2 is a schematic of the vehicular data acquisition and transmission device;

FIG. 3 is a schematic of a system for wireless acquiring vehicular data;

FIG. 4 is an alternative schematic of the vehicular data acquisition and transmission device; and

FIG. 5 is also an alternative schematic of the vehicular data acquisition and transmission device.

### DETAILED DESCRIPTION OF THE INVENTION

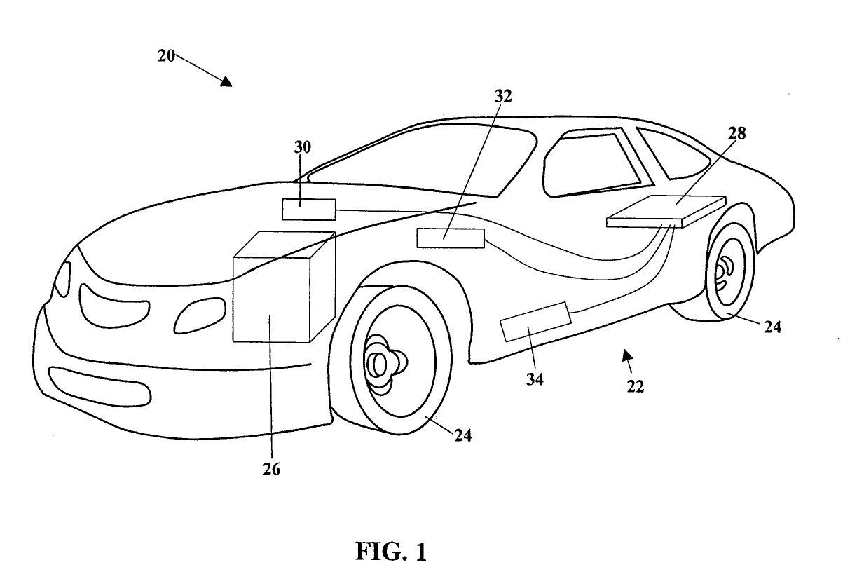

FIG. 1 is a schematic of a vehicle 20 incorporating a vehicular data acquisition and communication device 22. The vehicle includes at least one wheel and tire assembly 24, and at least one powertrain system 26 driving the at least one wheel and tire assembly 24. The vehicular data acquisition and communication device 22 includes a communication device 28. The communication device 28 communicates vehicular data. The communication device 28 receives vehicular data and initiates a communication representing or including the vehicular data. The vehicular data may include engine or powertrain management system information 30 from an engine, electric motor, or transmission system of the vehicle. The vehicular data may also include electrical management system information 32 from an electrical system of the vehicle or chassis management system information 34 from a chassis system of the vehicle.

The engine or powertrain management system information 30 includes information used to control engine and transmission performance. Many automotive manufacturers use one or more computers to control performance of an automobile's engine, transmission, and other powertrain components. (An Electronic Control Module, or “ECM,” is one example of an on-board computer used to control vehicular powertrains.) Sensors, switches, and actuators provide data to these computers, and these computers use this data to control emissions devices, cooling fans, ignition, air/fuel ratios, and many other performance variables. The communication device 28 can be used to communicate the information detected by these sensors, switches, and actuators.

The vehicular data acquisition and communication device 22 initiates communication. The vehicular data acquisition and communication device 22 automatically communicates engine or powertrain management system information 30. The vehicular data acquisition and communication device 22 need not be prompted or commanded to communicate the engine or powertrain management system information 30. The vehicular data acquisition and communication device 22 automatically communicates the engine or powertrain management system information 30. The vehicular data acquisition and communication device 22 can initiate a communication whenever a predetermined event occurs. The vehicular data acquisition and communication device 22, for example, can initiate a communication any time a diagnostic error code is detected. The vehicular data acquisition and communication device 22 could also initiate a communication at certain time intervals, mileage intervals, or any other interval or combination of intervals.

“Vehicular data,” as used herein, can be any signals or information used by the engine or powertrain management system. Vehicular data may include any of the sensor, switch, or actuator data collected by the engine or powertrain management system. Those skilled in the art recognize there are many sensors, switches, and actuators used in automobiles, and the number of sensors, switches, and actuators grows each model year. The vehicular data may include, for example, air intake temperature sensors, engine coolant sensors, throttle position sensors, manifold air pressure sensors, oxygen sensors, mass air flow sensors, ignition sensors, knock sensor, EGR sensors, and many other sensors.

“Vehicular data” may also include any diagnostic error codes flagged by the engine or powertrain management system. Sensors, switches, and actuators, as mentioned above, provide data to one or more on-board computers. These computers use this data to control emissions devices, cooling fans, ignition, air/fuel ratios, and many other components and performance variables. When these computers detect sensor inputs, or other inputs, that are outside of programmed limits, the computer often sets a diagnostic error code. The communication device 28 can be used to initiate a communication representing or containing this diagnostic error code.

The communication device 28 could initiate a wireless communication. Wirelessly transmitting engine or powertrain management system information 30 is greatly advantageous for vehicular service efforts. The vehicle's engine or powertrain management system information 30 could be automatically communicated to a dealership or manufacturer service center. The dealership or manufacturer service center would immediately be informed of any diagnostic error codes set by the engine or powertrain management system. Because the vehicular data acquisition and communication device 22 could also transmit a Vehicle Identification Number (VIN), the dealership or manufacturer service center would also know the customer name and any customer profile. The dealership or manufacturer service center could immediately determine the repair procedure for the diagnostic error code, and the dealership could immediately determine the availability of repair parts. If a repair part(s) is available, the dealership could contact the customer and make a service appointment. If a repair part(s) are not available, the dealership could automatically order the repair part and still contact the customer and make a service appointment.

Because the vehicular data acquisition and communication device 22 informs the dealership of engine or powertrain management system information 30, the dealership could even send a mobile repair team to the customer's home or work. If the vehicular data acquisition and communication device 22 also communicates the Vehicle Identification Number (VIN), the customer profile could inform the dealership of the customer's home address or work address. Thus, the vehicular data acquisition and communication device 22 could allow the dealership to repair the vehicle without the customer traveling to the dealership. The customer profile could be configured to show the customer's desired service hours, special needs, or any other information.

Wirelessly transmitting engine or powertrain management system information 30 is greatly advantageous for engineering development efforts. Because the vehicular data acquisition and communication device 22 initiates a communication representing engine or powertrain management system information 30, the vehicle manufacturer's engineering and warranty teams could be immediately informed of component or system quality issues. Wirelessly transmitting engine or powertrain management system information 30, for example, allows the engineering and warranty teams to quickly determine the root cause(s) of any errors detected by the engine or powertrain management system. The engineering and warranty teams can immediately begin formulating warranty and quality plans to eliminate the error. The vehicular data acquisition and communication device 22 allows manufacturers to very quickly respond to warranty and quality issues. Because vehicle manufacturers are quickly alerted to warranty and quality issues, the vehicular data acquisition and communication device 22 could greatly reduce the number of defective vehicles manufactured and the number of defective vehicles shipped to dealers.

As FIG. 1 shows, the vehicular data acquisition and communication device 22 could also communicate electrical management system information 32. The electrical management system information 32 includes information used to control the vehicle's electrical system. Many automotive manufacturers use one or more computers to control the vehicle's electrical system. Sensors, switches, and actuators provide data to these computers, and these computers use this data to detect under and over voltage or current conditions, open circuit conditions, circuit failures, power failures, battery failures, and many other electrical system concerns. The communication device 28 can be used to initiate a communication representing the condition of the vehicle electrical system.

As FIG. 1 also shows, the vehicular data acquisition and communication device 22 could also communicate chassis management system information 34. Today's vehicles are increasingly using one or more computers to control advanced chassis/suspension components. Hydraulic and/or pneumatic leveling systems, adaptive/active suspension systems, magneto-rheological suspension components, electric steering systems, and four wheel steering systems are just a few of the technological advances in chassis design. These chassis advances use one or more computers to control these systems. Steering wheel angle sensors, yaw, pitch, and roll accelerometer sensors, height sensors, shock absorber valving sensors, and many other chassis sensors, switches, and actuators are used to detect the state of the chassis system. The communication device 28 can be used to communicate the condition of the vehicle chassis system.

Those skilled in the art readily recognize “vehicular data,” as used herein, may also include any information used by the electrical management system and the chassis management system. Vehicular data may include any of the sensor, switch, or actuator data collected by the electrical management system and the chassis management system. Sensor data, switch data, actuator data, and even error codes can be wirelessly communicated by the vehicular data acquisition and communication device 22. Even maintenance schedules could be communicated so that dealers could automatically schedule and perform maintenance procedures.

Those skilled in the art also readily recognize the advantages of wirelessly communicating electrical management system information 32 and the chassis management system information 34. Dealership service groups, like a vehicle manufacturer's warranty and engineering teams, can quickly learn of vehicle quality or maintenance concerns. Dealers and manufacturers can quickly respond and formulate action plans. Because vehicle manufacturers and dealers are quickly alerted to warranty and quality issues, the vehicular data acquisition and communication device 22 could greatly reduce the number of defective vehicles manufactured and the number of defective vehicles shipped to dealers.

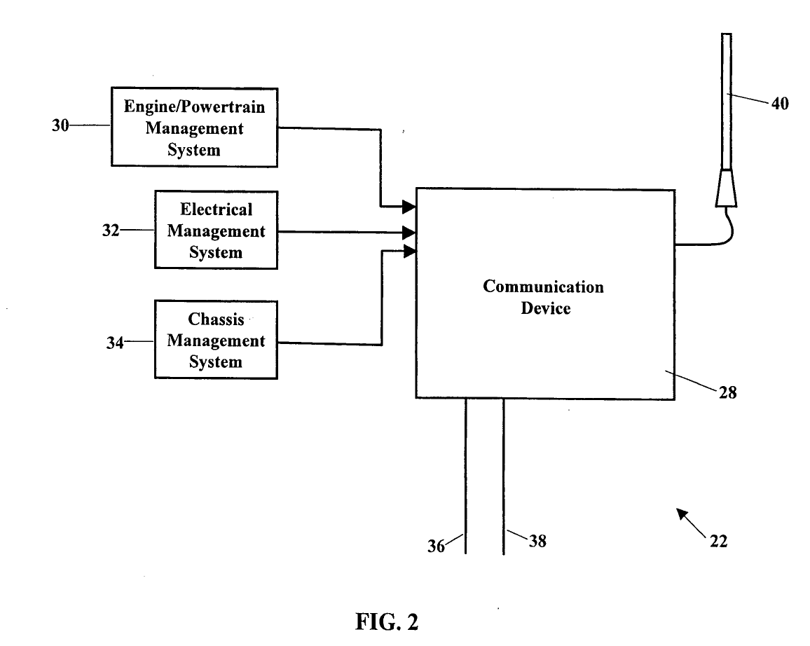

FIG. 2 is a schematic of the vehicular data acquisition and communication device 22. The communication device 28 receives engine or powertrain management system information 30, electrical management system information 32, and chassis management system information 34. FIG. 2 shows the communication device may have power inputs 36 and 38, and the communication device may include an antenna 40.

The communication device 28 can be any means for communicating the vehicular data. As those skilled in the art recognize, the communication device 28 may be a cellular phone device, a paging device, or a satellite communication device. The communication device 28 may operate on any frequency or any portion of the electromagnetic spectrum (e.g., RF, infrared). The communication device 28 may also be analog or digital.

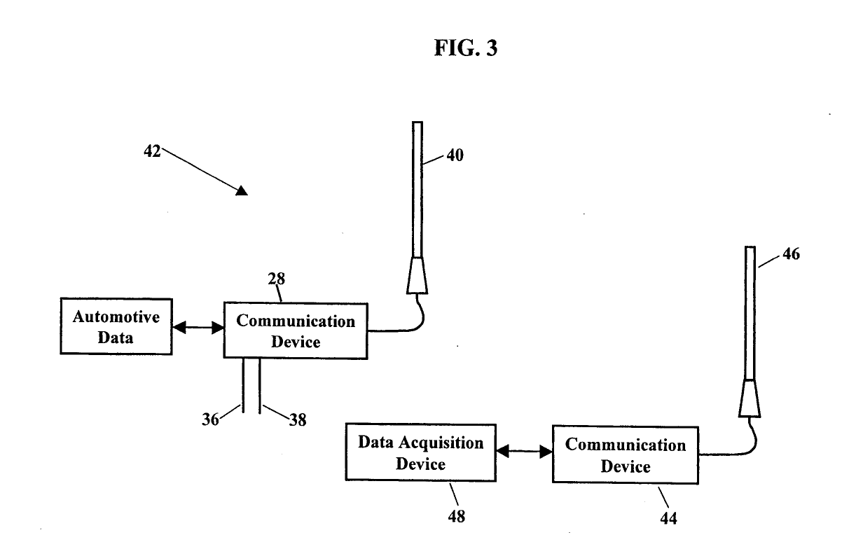

FIG. 3 is a schematic of a system 42 for wirelessly acquiring vehicular data. The system 42 includes the vehicular data acquisition and communication device 22. The communication device 28 receives the vehicular data and wirelessly transmits the vehicular data. At least one other communication device 44 wirelessly receives the vehicular data from the communication device 28. The at least one other communication device 44 may also have an antenna 46, and the vehicular data is communicated from the at least one other communication device 44 to one or more data acquisition devices 48. Those skilled in the art recognize the one or more data acquisition devices 48 can be a personal computer, laptop computer, or any other data storage device.

FIG. 3 also shows a method of communicating the vehicular data. The method includes initiating a communication representing the vehicular data. The method could include initiating a wireless communication of the vehicular data from the vehicle to a dealership. The method may include initiating a communication of the vehicular data from the dealership to a manufacturer. The method could include initiating a communication of the vehicular data over the Internet from the dealership to the manufacturer. The method additionally could include initiating a wireless communication of the vehicular data from the dealership to a manufacturer or from the vehicle to a manufacturer. The method alternatively could include initiating a wireless communication of the vehicular data from the vehicle to a rental agency.

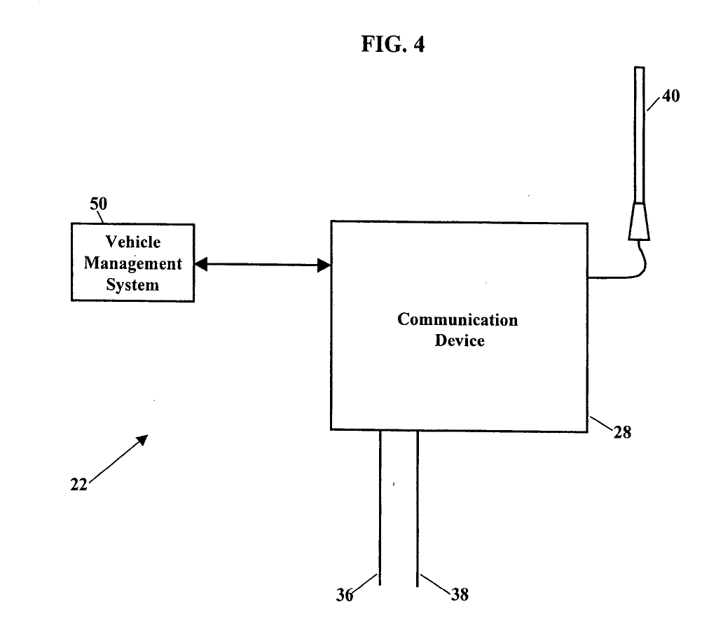

FIG. 4 is an alternative schematic of the vehicular data acquisition and communication device 22. FIG. 4 shows the communication device 28 receiving vehicle management system information 50. FIG. 4 acknowledges that the separate computers shown in FIGS. 1 and 2, and used to control the engine or powertrain management system, the electrical management system, and the chassis management system, may be combined into one vehicle management system. This vehicle management system would reduce vehicle component costs by having a single computer or controller control all subsystems of the vehicle. Thus, the communication device 28 would receive vehicle management system information 50 from a single vehicle computer.

Those skilled in the art also recognize the vehicular data acquisition and communication device 22 could receive direct inputs from any management system. As FIG. 4 suggests, any engine, powertrain, electrical, or chassis management system used in a vehicle could send direct inputs to the vehicular data acquisition and communication device 22. A wiring harness or cable could plug from any computer or controller in the vehicle to the communication device 28. This type of connectivity would eliminate translators or other software measures between each computer and the vehicular data acquisition and communication device 22.

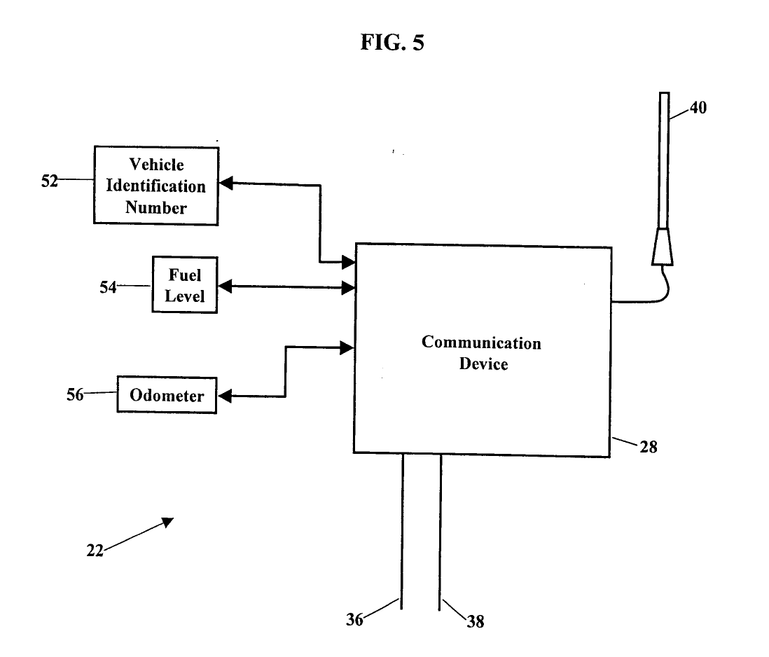

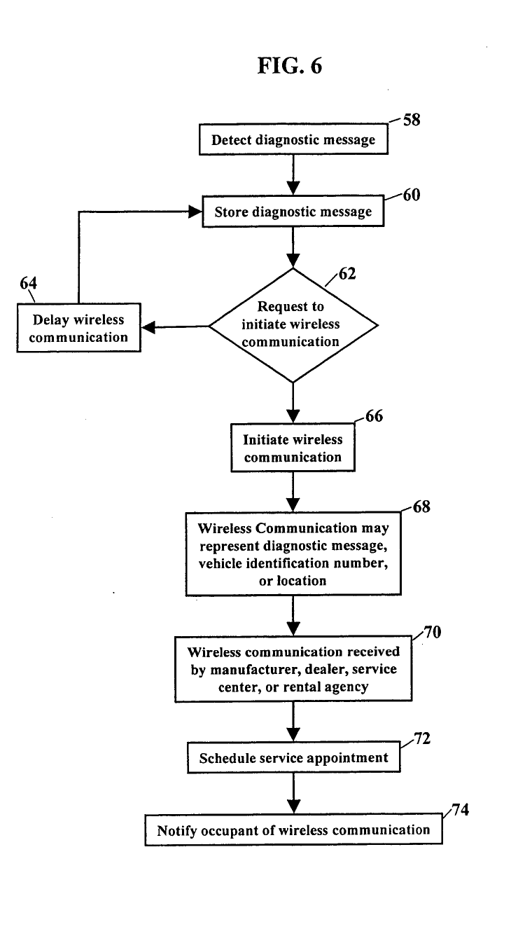

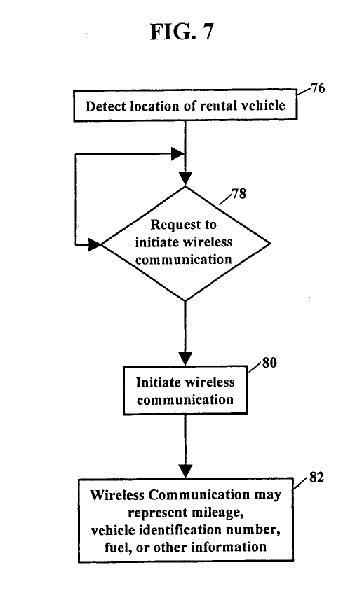

FIG. 5 is also an alternative schematic of the vehicular data acquisition and communication device 22. FIG. 5 shows the vehicular data acquisition and communication device 22 specially configured for rental operations. The communication device 28 could receive vehicular data such as Vehicle Identification Number (VIN) 52, fuel level 54, and odometer 56. The vehicular data acquisition and communication device 22 shown in FIG. 5 would allow all rental customers to simply park the vehicle at the rental agency and immediately proceed to an airline gate or other destination. The rental agency would immediately know the VIN, the fuel level, and the odometer. The vehicular data acquisition and communication device 22 greatly speeds the return of rental vehicles and promotes further rental customer satisfaction. Because the vehicular data acquisition and communication device 22 communicates VIN, fuel, and mileage, the rental agency can also reduce labor costs from the rental return procedure.

Rental agencies could still provide the customer with a receipt of the rental transaction. Although the vehicular data acquisition and communication device 22 eliminates the customer from having to log and/or report fuel and mileage, the customer may still need a receipt of the rental transaction. The vehicular data acquisition and communication device 22, for example, would allow the rental agency to print a receipt on a bus or other rental agency ground transportation. The customer could simply return the vehicle, immediately walk to the rental agency bus, and a printed receipt would be available from the driver or from a terminal in the bus. The agency could, of course, imply email a receipt to the rental customer.

Other features of the vehicular data acquisition and communication device 22 are security and convenience. The vehicular data acquisition and communication device 22 could be designed to only transmit vehicular data when prompted. This feature would save power and would also prevent personal data from unnecessary transmission. A rental agency or dealer, for example, could “ping” or prompt the vehicular data acquisition and communication device 22 when the vehicle is within range. The vehicular data acquisition and communication device 22 would then communicate the vehicular data. The vehicular data acquisition and communication device 22 could also be prompted for vehicular data (such as VIN) when the vehicle has been stolen. Triangulation, GPS, or other methods could be used to pinpoint the location of a stolen vehicle communicating vehicular data. The vehicular data acquisition and communication device 22 could also be used to facilitate electronic commerce. The vehicular data acquisition and communication device 22 could transmit credit card information to a local gas station or other vendor. When the gas station or vendor prompts the vehicular data acquisition and communication device 22, an e-commerce payment would be electronically made. Likewise, the vehicular data acquisition and communication device 22 could initiate an emergency communication (such as dialing 911) at a predetermined sensor value. For example, an accelerometer value representing a collision could cause the vehicular data acquisition and communication device 22 to initiate a communication to police, to emergency crews, to family or friends, or any other entity. Triangulation, GPS, or other methods could be used to pinpoint the location of the vehicle initiating the communication.

Although FIG. 1 shows an automobile, those skilled in the art recognize the vehicular data acquisition and communication device 22 is certainly applicable to other vehicular transportation platforms. Light, medium, and heavy-duty trucks, for example, may also utilize the vehicular data acquisition and communication device 22 to communicate vehicular data. Boats, ships, and aircraft may also utilize the vehicular data acquisition and communication device 22 to communicate vehicular data. The vehicular data acquisition and communication device 22 is also applicable to hybrid-electric vehicles and electric vehicles. Even generators, lawn equipment, electric golf carts, and any other platform using a combustion engine(s) or electric motor(s) can utilize the vehicular data acquisition and communication device 22 to communicate the vehicular data.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

What is claimed is:

1. A method of returning a rental vehicle to a rental agency facility, comprising:
detecting a location of the rental vehicle; and
commanding the rental vehicle to wirelessly communicate diagnostic information.

2. A method of returning the rental vehicle according to claim 1, wherein the diagnostic information comprises at least one of mileage of the rental vehicle, fuel contained in the rental vehicle, and a number identifying the rental vehicle.

3. A method of returning the rental vehicle according to claim 2, further comprising generating a receipt using the diagnostic information.

4. A method of returning the rental vehicle according to claim 3, further comprising wirelessly communicating the receipt to a rental agency bus.

5. A method of returning the rental vehicle according to claim 4, further comprising printing the receipt at the rental agency bus.

6. A method of returning the rental vehicle according to claim 1, wherein the step of detecting the location of the rental vehicle comprises detecting the rental vehicle entering the rental agency facility.

7. A method of returning a rental vehicle to a rental agency facility, comprising:
wirelessly receiving diagnostic information from the rental vehicle; and
forwarding the diagnostic information to the rental agency.

8. A method of returning the rental vehicle according to claim 7, further comprising associating the rental vehicle to the rental agency.

9. A method of returning the rental vehicle according to claim 7, further comprising associating a Vehicle Identification Number of the rental vehicle to the rental agency.

10. A method of returning the rental vehicle according to claim 7, further comprising associating a Vehicle Identification Number of the rental vehicle to the rental agency renting the vehicle.

11. A method of returning the rental vehicle according to claim 7, wherein the step of forwarding the diagnostic information to the rental agency comprises forwarding at least one of mileage of the rental vehicle, fuel contained in the rental vehicle, and a number identifying the rental vehicle to the rental agency.

12. A method of returning the rental vehicle according to claim 7, wherein the step of wirelessly receiving the diagnostic information comprises wirelessly receiving the diagnostic information by a manufacturer of the rental vehicle.

13. A method of returning the rental vehicle according to claim 7, wherein the step of forwarding the diagnostic information comprises forwarding the diagnostic information from a manufacturer of the rental vehicle to the rental agency.

14. A method of returning the rental vehicle according to claim 7, wherein the step of forwarding the diagnostic information comprises forwarding the diagnostic information to the rental agency via the Internet.

15. A method of returning a rental vehicle to a rental agency facility, comprising:
receiving diagnostic information from a manufacturer of the rental vehicle; and
generating a record of a rental transaction using the diagnostic information.

16. A method of returning the rental vehicle according to claim 15, further comprising generating a receipt of the rental transaction.

17. A method of returning the rental vehicle according to claim 16, further comprising wirelessly communicating the receipt to a rental agency bus.

18. A method of returning the rental vehicle according to claim 16, further comprising printing the receipt at a rental agency bus.

19. A method of returning the rental vehicle according to claim 16, further comprising emailing the receipt.

20. A method of returning the rental vehicle according to claim 15, further comprising requesting a manufacturer of the rental vehicle to obtain the diagnostic information.
